(19) United States
(12) Patent Application Publication
(10) Pub. No.: US 2019/0026632 A1
(43) Pub. Date: Jan. 24, 2019

(54) INFORMATION PROCESSING DEVICE, INFORMATION PROCESSING METHOD, AND RECORDING MEDIUM

(71) Applicant: NEC CORPORATION, Tokyo (JP)

(72) Inventor: Masanao NATSUMEDA, Tokyo (JP)

(73) Assignee: NEC CORPORATION, Tokyo (JP)

(21) Appl. No.: 16/069,724

(22) PCT Filed: Jan. 19, 2017
(86) PCT No.: PCT/JP2017/001671

§ 371 Date: Jul. 12, 2018

(30) Foreign Application Priority Data
Jan. 21, 2016 (JP) 2016-009879

(51) Int. Cl. G06N 3/12; G06N 5/02; G06F 17/50

(52) U.S. Cl. CPC G06N 3/126; G06F 17/5009; G06N 5/022

(57) ABSTRACT

A model with few false reports and little missing detection is generated even if the number of models is large. A system analysis device 1 includes a feature acquisition unit 1211 and a selection unit 1221. The feature acquisition unit 1211 acquires a feature of a first data item. The selection unit 1221 selects a model for learning a relationship between the first data item and a second data item, based on the feature.

### TECHNICAL FIELD

The present invention relates to an information processing device, an information processing method, and a recording medium, and more particularly, to an information processing device, an information processing method, and a recording medium for analyzing a system.

### BACKGROUND ART

A system analysis device performing a process of analyzing a state of a system, based on sensor data acquired from a component of the system, is used. Such an analysis process is performed for operating the system safely and efficiently. One of analysis processes detects an abnormality of the system with a multivariate analysis on the sensor data. This analysis process notifies, when an abnormality of the system is detected, an occurrence of the abnormality to an operator or the system. Such analysis allows detection of an abnormality at an early stage and minimization of damage due to the abnormality by advancing an initial action to take measures.

In the multivariate analysis on sensor data, an estimated value of the sensor data is calculated, and an abnormality of a system is detected, based on an estimation error being a difference between the estimated value and a measurement value corresponding to the estimated value. In order to obtain an estimated value of sensor data, a mathematical model (hereinafter also described as a model) approximating a relationship between sensors may be used. Some pieces of sensor data acquired from an actual system include a value at a certain time being affected by a past value. A relationship between sensors with respect to such sensor data is accurately approximated with an approximate model including an autoregressive process.

For example, PTL 1 describes a technology for detecting an abnormality by using a model including an autoregressive process. In the technology described in PTL 1, a parameter of a model including an autoregressive process is obtained by a least square method, and an abnormality is detected by using the model.

Further, for example, PTL 2 describes a technology for estimating a parameter of a model with high accuracy by using transcendental information when approximating a relationship with a model including an autoregressive process.

In the technology described in PTL 2, transcendental information is prepared for each relationship between sensors having an obvious input/output relationship, and a parameter of the model is estimated by using the transcendental information as a constraint for the parameter of the model.

A location in which an abnormality occurs cannot be previously known in a system. Thus, monitoring as many relationships between sensors as possible is effective for early detection of an abnormality. For example, PTL3 describes a technology for comprehensively monitoring relationships including not only a relationship between sensors having an obvious input/output relationship but also a relationship between sensors having a non-obvious input/output relationship, and detecting an abnormality.

In the technology described in PTL 3, a model is generated for each combination of two arbitrary sensors among a plurality of sensors, and an abnormality is detected for each model.

### CITATION LIST

### Patent Literature

PTL 1: Japanese Patent No. 4520819

PTL 2: Japanese Patent Application Laid-open Publication No. 2008-287343

PTL 3: Japanese Patent No. 4872944

### SUMMARY OF INVENTION

### Technical Problem

Generating a model including an autoregressive process as in the technology described in PTL 1 described above for each combination of sensors as in the technology described in PTL 3 allows detection of an abnormality occurring in various locations in a system at an early stage.

However, in the technology described in PTL 1, a parameter of a model is obtained by the least square method. When a model including an autoregressive process is obtained by the least square method, a parameter of the model may over-fit to learning data. As a result, using the model including an autoregressive process to detect an abnormality may cause a false report and missing detection.

Further, in the technology described in PTL 2, over-fitting of a parameter of a model to learning data is resolved by using the transcendental information regarding an input and an output. However, an application target of the technology described in PTL 2 is limited to a model between sensors having an obvious input/output relationship, and therefore the technology is not applicable to a case where a relationship between sensors is modeled for general purposes. In addition, the transcendental information is obtained from theoretical or experiential knowledge and an experiment. Thus, when the number of models is large, there is an issue that the transcendental information cannot be always prepared for all models or it takes an enormous cost for preparing the transcendental information.

An example object of the present invention is to solve the above-described issue and provide an information processing device, an information processing method, and a recording medium, capable of generating a model with few false reports and little missing detection even if the number of models is large.

### Solution to Problem

An information processing device according to an exemplary aspect of the present invention includes: feature acquisition means for acquiring a feature of a first data item; and selection means for selecting a model for learning a relationship between the first data item and a second data item, based on the feature.

An information processing method according to an exemplary aspect of the present invention includes: acquiring a feature of a first data item; and selecting a model for learning a relationship between the first data item and a second data item, based on the feature.

A computer readable storage medium records thereon a program causing a computer to perform a method including: acquiring a feature of a first data item; and selecting a model for learning a relationship between the first data item and a second data item, based on the feature.

### Advantageous Effects of Invention

An advantageous effect of the present invention is that, even if the number of models is large, a model with few false reports and little missing detection can be generated.

### BRIEF DESCRIPTION OF DRAWINGS

FIG. 1 is a block diagram illustrating a characteristic configuration of a first example embodiment of the present invention.

FIG. 2 is a block diagram illustrating a configuration of a system analysis device 1 in the first example embodiment of the present invention.

FIG. 3 is a block diagram illustrating an example of a hardware configuration of the system analysis device 1 in the first example embodiment of the present invention.

FIG. 4 is a flowchart illustrating overall operation of the system analysis device 1 in the first example embodiment of the present invention.

FIG. 5 is a flowchart illustrating details of an analysis model generation process (Step S3) of the system analysis device 1 in the first example embodiment of the present invention.

FIG. 6 is a diagram illustrating examples of generating an analysis model in the first example embodiment of the present invention.

FIG. 7 is a block diagram illustrating a configuration of the system analysis device 1 in a second example embodiment of the present invention.

FIG. 8 is a flowchart illustrating details of the analysis model generation process (Step S3) of the system analysis device 1 in the second example embodiment of the present invention.

FIG. 9 is a block diagram illustrating a configuration of the system analysis device 1 in a third example embodiment of the present invention.

FIG. 10 is a flowchart illustrating details of the analysis model generation process (Step S3) of the system analysis device 1 in the third example embodiment of the present invention.

### EXAMPLE EMBODIMENT

Example embodiments of the present invention will be described in detail with reference to drawings. Note that, in each of the drawings and each of the example embodiments in the specification, the same components have the same reference signs, and description thereof will be appropriately omitted.

### First Example Embodiment

A first example embodiment of the present invention will be described.

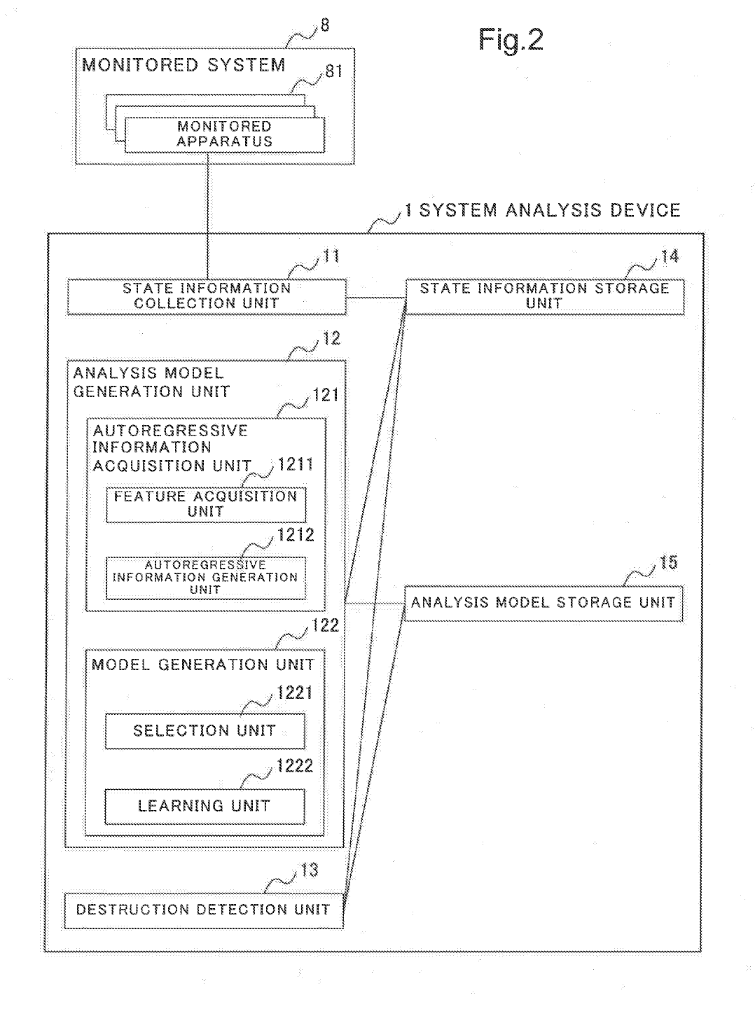

A configuration of the first example embodiment of the present invention will be described. FIG. 2 is a block diagram illustrating a configuration of a system analysis device 1 in the first example embodiment of the present invention. With reference to FIG. 2, the system analysis device 1 includes a state information collection unit 11, an analysis model generation unit 12, a destruction detection unit 13, a state information storage unit 14, and an analysis model storage unit 15. The system analysis device 1 is connected to a monitored system 8. The system analysis device 1 is one example embodiment of the information processing device of the present invention.

The system analysis device 1 detects an abnormality of the monitored system 8 by analyzing a state of the monitored system 8 and then outputs a detection result.

The monitored system 8 is a system monitored by the system analysis device 1. The monitored system 8 is a unity or a mechanism formed of elements that affect each other, such as an information and communication technology (ICT) system, a chemical plant, a generating plant, and power equipment. The monitored system 8 includes one or more monitored apparatuses 81 as an element. For example, when the monitored system 8 is a power generating plant system, the monitored apparatus 81 is a turbine, a water supply heater, a condenser, and the like. Further, the monitored apparatus 81 may include an element for connecting apparatuses, such as piping and a signal line. The monitored system 8 may be the whole system like a power generating plant system or a portion that realizes a part of functions in a certain system.

Each of the monitored apparatuses 81 measures a sensor value being a value obtained from a sensor provided in the monitored apparatus 81 every predetermined timing, and transmits the sensor value to the system analysis device 1. Hereinafter, not only an actual hardware sensor like a normal measuring instrument but also a soft sensor, a control signal, and the like are each referred to as a sensor. The sensor value is a measurement value, such as a degree of opening of a valve, a height of a liquid level, a temperature, a flow rate, pressure, a current, and a voltage, measured by a measuring instrument installed in equipment. The sensor value may also be an estimated value calculated from the measurement value. The sensor value may also be a value of a control signal generated and sent by the information processing device to bring the system into an intended operational state. The sensor value may also be a value such as a central processing unit (CPU) usage rate, a memory usage rate, an amount of network transmission and reception, and the like that are acquired from an operating system. Hereinafter, each sensor value is expressed by a numerical value such as an integer or a decimal.

Further, in the example embodiments of the present invention, one data item is allocated to each sensor provided in each of the monitored apparatuses 81. In addition, a set of sensor values of a plurality of data items collected at timings considered to be the same from the respective monitored apparatuses 81 is referred to as state information. Herein, “collected at timings considered to be the same” may also represent measurement at the same time or times within a predetermined range by the monitored apparatuses 81. Further, “collected at timings considered to be the same” may also represent collection by a series of collection processes of the system analysis device 1. Note that, a storage device (not illustrated) that stores sensor values acquired by the monitored apparatus 81 may be provided between the monitored apparatus 81 and the system analysis device 1. Such a storage device may also be, for example, a data server, a distributed control system (DCS), a process computer, or the like. In this case, the monitored apparatus 81 acquires sensor values at arbitrary timing and stores the sensor values in the storage device. Then, the system analysis device 1 may read the sensor values stored in the storage device at a predetermined timing. In addition, when sensor values are missing or timings for collecting respective sensor values are different, sensor values may be complemented by an arbitrary method such that the timings for collecting the sensor values are considered to be the same.

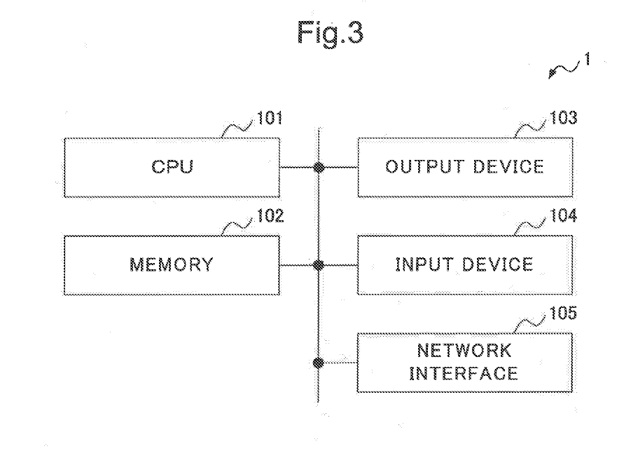

FIG. 3 is a block diagram illustrating an example of a hardware configuration of the system analysis device 1 in the first example embodiment of the present invention. The system analysis device 1 may be implemented on a computer device including hardware elements as illustrated in FIG. 3. In FIG. 3, the system analysis device 1 includes a CPU 101, a memory 102, an output device 103, an input device 104, and a network interface 105. The memory 102 is a random access memory (RAM), a read only memory (ROM), an auxiliary storage device (such as a hard disk), and the like. The output device 103 is a device that outputs information, such as a display device and a printer. The input device 104 is a device that receives an input of a user operation, such as a keyboard and a mouse. The network interface 105 is an interface connected to a network. In this case, each of the functional blocks of the system analysis device 1 is implemented on the CPU 101 that reads and executes a computer program stored in the memory 102, and also controls the output device 103, the input device 104, and the network interface 105. Note that, the hardware configuration of the system analysis device 1 and each of the functional blocks of the system analysis device 1 is not limited to the above-described configuration.

Next, details of each of the functional blocks of the system analysis device 1 will be described.

The state information collection unit 11 collects state information of the monitored system 8 at predetermined timings and stores the state information in the state information storage unit 14. Hereinafter, time-series data of state information is also described as state-series information.

The state information storage unit 14 stores the state information collected by the state information collection unit 11 as state-series information. The state information storage unit 14 may store information indicating a collection time and the state information in association with each other, for example. The state information storage unit 14 has a storage area for storing state-series information for at least a predetermined period.

The analysis model generation unit 12 generates an analysis model of the monitored system 8. The analysis model is a set of one or more correlation models (correlation model group). The correlation model (hereinafter also simply described as a model) includes, for arbitrary data items equal to or more than two among a plurality of data items in state information of the monitored system 8, a regression equation defining a relationship between the data items and an allowable range of an error in an estimated sensor value by the regression equation. The number of data items of each of the correlation models included in the analysis model may vary. The analysis model generation unit 12 stores the generated analysis model in the analysis model storage unit 15.

Herein, an operator or the like set an arbitrary period during which a failure did not occur in the monitored system 8, as a predetermined period of state-series information used by the analysis model generation unit 12 to generate an analysis model, for example. The predetermined period may be the shortest possible period in such a way as not to be affected by aged deterioration of the monitored system 8, from a viewpoint of enhancing sensitivity of abnormality detection. For example, when a maintenance cycle of the monitored system 8 is one year, a period of a month, a week, a day, or the like that is sufficiently shorter than the maintenance cycle is used as the predetermined period. Further, a period affected by a factor that brings a great change in the most sensor values, among factors of changes in a state of the system that may usually occur, may be used as the predetermined period, in order to include a significant change in state-series information. On the other hand, the predetermined period may be the longest possible period in such a way as to comprehensively include a change in sensor value due to a main internal or external factor, from a viewpoint of reducing false detection due to a change in a state of the monitored system 8. For example, when the monitored system 8 is greatly affected by a season, a period of nine months, a year, or the like is used as the predetermined period. Further, state-series information used to generate an analysis model may also be extracted from a plurality of periods instead of one continuous period.

The analysis model generation unit 12 includes an autoregressive information acquisition unit 121 and a model generation unit 122.

The autoregressive information acquisition unit 121 acquires autoregressive information of each data item. The autoregressive information indicates, when each of the data items is used as a response variable in a correlation model, whether or not the correlation model may include an autoregressive process.

The autoregressive information acquisition unit 121 includes a feature acquisition unit 1211 and an autoregressive information generation unit 1212.

The feature acquisition unit 1211 acquires feature information indicating a feature of each of the data items, as information for generating autoregressive information of each of the data items. Herein, the feature acquisition unit 1211 calculates, as a feature of each of the data items, a fitness score of the data item for an autoregressive process (hereinafter also described as a first fitness score), for example. The fitness score for the autoregressive process may be any indicator as long as it indicates a degree of inclusion of autoregressive process in time-series data of each of the data items. For example, a fitness score for an autoregressive model (autoregressive equation) like Equation 1 described below may be used, as the fitness score for the autoregressive process. Alternatively, an average value of absolute values of autocorrelation functions from a delay time 0 to a predetermined delay time or a sum total of parameters aᵢ in the autoregressive model like Equation 1 described below may be used, as the fitness score for the autoregressive process.

The feature acquisition unit 1211 may use an arbitrary period without a failure, as a period of state-series information used to acquire feature information (a fitness score for an autoregressive process of a data item). Herein, the feature acquisition unit 1211 may use the state-series information of a predetermined period used to generate an analysis model in order to generate autoregressive information, from a viewpoint of increasing consistency with an analysis result with the analysis model.

Hereinafter, a case where a fitness score for an autoregressive model is used as a fitness score for an autoregressive process of a data item will be described.

The feature acquisition unit 1211 generates an autoregressive model (autoregressive equation) including one data item like Equation 1, for state-series information of a predetermined period, for example.

$${u}^{′} ( t ) = f ( u ) = {\sum }_{i = 1}^{N} {a}_{i} u ( t - i ) + c \qquad [ Equation 1 ]$$

In Equation 1, t represents an index of state information. The index t of the state information is provided with serial integers whose values are increased in order of occurrence, for pieces of state information arranged in order of occurrence. u(t) represents a sensor value of a data item u of the state information with the index t. u′(t) is a response variable of an autoregressive model, and is an estimated value of the sensor value of the data item u of the state information with the index t. u(t−i) is an explanatory variable of the regression equation, and represents a sensor value of the data item u of the state information with an index t−i. f(u) represents that the regression equation is a function using one data item (u) as an explanatory variable. N is an arbitrary integer. Note that, Equation 1 is one example of the autoregressive model, and the autoregressive model is not limited to this form. For example, an equation excluding a constant term c from Equation 1 or an equation having t−i−k instead of t−i may be used as the autoregressive model. Herein, k is an arbitrary integer. For example, k may be a predetermined constant. k may be determined from among a plurality of predetermined values, in such a way as to maximize the fitness score for the autoregressive process described below.

The feature acquisition unit 1211 determines aᵢ, c, and N being parameters in Equation 1, in such a way as to maximize the fitness score of the data item u used as a response variable for the autoregressive equation. Herein, the feature acquisition unit 1211 calculates a fitness score F₁ by using an estimation accuracy of the regression equation as expressed in Equation 2 below, for example.

$${F}_{1} = [ 1 - \sqrt{\frac{{\sum }_{t = N 0}^{N 1} {\{ u ( t ) - {u}^{′} ( t ) \}}^{2}}{{\sum }_{t = N 0}^{N 1} {\{ u ( t ) - \overline{u} ( t ) \}}^{2}}} ] \qquad [ Equation 2 ]$$

In Equation 2, u with a bar represents an average value of response variables over a predetermined period included in state-series information. Note that, the predetermined period is a learning period for determining a parameter in Equation 1, and is a period in which the index t of the state information is N0 to N1 (N0≤t≤N1). Herein, N0 and N1 respectively represent an index at the oldest time and an index at the newest time of the state information used to construct the regression equation.

As a viewpoint of a fitness score, a viewpoint of high estimation accuracy and a viewpoint of low generalization error can be determined. Equation 2 is an example of a fitness score determined from the viewpoint of a high estimation accuracy. Alternatively, a fitness score may be determined from the viewpoint of a low generalization error. When a fitness score is determined from the viewpoint of a low generalization error, the fitness score F₁ can be calculated by using an information criterion, for example. Further, the fitness score F₁ may be calculated by combining techniques of these viewpoints.

Parameters that maximize the fitness score F₁ may be determined by determining aᵢ and c in such a way as to maximize the fitness score F₁ with respect to each value of N, and then selecting the parameters aᵢ and c of N that maximizes the fitness score F₁, for example. Alternatively, a general method for determining parameters, such as a least square method and a partial least square (PLS) method, may be used as a method for determining the parameters aᵢ and c. The maximum value of N may be arbitrarily set by the operator or the like.

The autoregressive information generation unit 1212 generates the autoregressive information by determining whether a feature (the fitness score F₁) acquired by the feature acquisition unit 1211 satisfies a predetermined condition, for example. The autoregressive information generation unit 1212 uses Equation 3 below as the predetermined condition to generate the autoregressive information.

F₁≥Fₜₕ₁ [Equation 3]

In Equation 3, Fₜₕ₁ is a threshold value of the fitness score F₁ (hereinafter also described as a first threshold value). An arbitrary value is set as a value of Fₜₕ₁ by the operator or the like.

When the fitness score F₁ is equal to or more than the threshold value Fₜₕ₁, the autoregressive information generation unit 1212 determines not to include the autoregressive process in a correlation model using the data item as a response variable (autoregressive process is disabled). In this case, the autoregressive information generation unit 1212 sets one to the autoregressive information, for example. On the other hand, when the fitness score F₁ is less than the threshold value Fₜₕ₁, the autoregressive information generation unit 1212 determines to allow including the autoregressive process in the correlation model using the data item as a response variable (autoregressive process is enabled). In this case, the autoregressive information generation unit 1212 sets zero to the autoregressive information, for example. The autoregressive information generation unit 1212 sets the determination result to the autoregressive information. Note that, a condition that “the fitness score F₁ is equal to or more than the threshold value Fₜₕ₁” is a “predetermined fitting condition for the first fitness score”.

In this way, the autoregressive information acquisition unit 121 generates autoregressive information for each data item.

Note that, the autoregressive information acquisition unit 121 may acquire autoregressive information for each data item previously stored in a storage unit (not illustrated), instead of generating autoregressive information. Alternatively, the autoregressive information acquisition unit 121 may acquire autoregressive information input from the outside via the input device 104, the network interface 105, a portable recording medium, or the like.

The model generation unit 122 generates each correlation model, based on state-series information stored in the state information storage unit 14 and autoregressive information.

The model generation unit 122 includes a selection unit 1221 and a learning unit 1222.

The selection unit 1221 selects a form of a correlation model to be learned by the learning unit 1222, based on autoregressive information for a data item used as a response variable of a regression equation of the correlation model. When a form of a correlation model used as a base of generation (base correlation model) includes the autoregressive process, the selection unit 1221 selects a form of a correlation model, from the base correlation model and a correlation model obtained by excluding the autoregressive process from the base correlation model. When the autoregressive information indicates that “autoregressive process is enabled”, the selection unit 1221 selects the correlation model including the autoregressive process. On the other hand, when the autoregressive information indicates that “autoregressive process is disabled”, the selection unit 1221 selects the correlation model not including the autoregressive process. When the base correlation model does not include the autoregressive process, the selection unit 1221 selects the base correlation model regardless of the autoregressive information.

Note that, a form of the base correlation model (such as data items used as an explanatory variable and a response variable, the number of terms and a degree of past values for the explanatory variable, and presence or absence of a constant term) may be previously provided by the operator or the like. Alternatively, the model generation unit 122 or the like may determine a form of the base correlation model according to a predefined rule as in PTL 3.

For example, a regression equation including two data items like Equation 4 is used as the base correlation model.

$${u}^{″} ( t ) = f ( u , x ) = {\sum }_{i = 1}^{N} {\sum }_{j = 1}^{K} {a}_{ij} {u ( t - j )}^{i} + {\sum }_{l = 1}^{M} {b}_{l} {x ( t )}^{l} + d \qquad [ Equation 4 ]$$

In Equation 4, u″(t) is a response variable of the correlation model and is a predicted value of the data item u of the state information with the index t. u(t−j) represents a value of the data item u of the state information with an index t−j. u(t−j)ⁱ and x(t)^{l} are explanatory variables in the regression equation. u(t−j)ⁱ represents a value obtained by calculating a sensor value of the data item u of the state information with the index t−j to the i-th power. x(t)^{l} represents a value obtained by calculating a sensor value of a data item x of the state information with the index t to the l-th power. f(u, x) represents that the regression equation is a function using two data items (u, x) as explanatory variables. N, K, and M are arbitrary integers.

Herein, when the autoregressive information for the data item u indicates that “autoregressive process is disabled”, the selection unit 1221 selects an equation excluding the autoregressive process that is the first term on the right side in Equation 4, as the regression equation of the correlation model. On the other hand, when the autoregressive information for the data item u indicates that “autoregressive process is enabled”, the selection unit 1221 selects Equation 4, as the regression equation of the correlation model.

The learning unit 1222 learns a relationship between data items with the regression equation of the correlation model selected by the selection unit 1221. Herein, the learning unit 1222 determines parameters aᵢⱼ, bₗ, and d of Equation 4 by, for example, the same method as the method for determining the parameters of Equation 1.

The learning unit 1222 further determines an allowable range of an estimation error in the regression equation of the learned correlation model. Herein, the learning unit 1222 determines, for example, a range satisfying both of Equation 5 and Equation 6, as the allowable range.

rₜ≤T₁ [Equation 5]

rₜ≥T₂ [Equation 6]

Herein, T₁ is a maximum threshold value for an estimation error. T₂ is a minimum threshold value for the estimation error. rₜ is an estimation error in a predicted value of a response variable calculated by using the regression equation of the correlation model for the state information with the index t.

The learning unit 1222 determines the maximum threshold value T₁ and the minimum threshold value T₂ in Equation 5 and Equation 6 by using, for example, Equation 7 and Equation 8, respectively.

T₁=max{|R_{N0}|, . . . ,|R_{N1}|} [Equation 7]

T₂=−T₁ [Equation 8]

Herein, max { } is a function that outputs a maximum value from input numerical values. Further, |x| is an operator that extracts an absolute value of x. Further, Rₜ (t=N0 to N1) is an estimation error in a predicted value of a response variable, with respect to the state information with the index t, calculated from the state-series information used to learn the correlation model. N0 represents an index of state information at the oldest time among the state information used to learn the correlation model. N1 represents an index of the state information at the newest time among the state information used to learn the correlation model.

In other words, in Equation 7, a maximum value of absolute values of estimation errors calculated for the state-series information over a period used to learn the correlation model (hereinafter, referred to as estimation errors during a calculation period) is used, as the maximum threshold value T₁ of the allowable range. Further, in Equation 8, a value obtained by multiplying, by −1, the maximum value of the absolute values of the estimation errors during the calculation period is used, as the minimum threshold value T₂ of the allowable range.

Note that, the learning unit 1222 may also determine the maximum threshold value T₁ and the minimum threshold value T₂, by using an average value and a standard deviation of estimation errors R_{N0} to R_{N1} during the above-described calculation period instead of Equation 7 and Equation 8. For example, the learning unit 1222 may use a value obtained by adding three times the standard deviation to the average value of the estimation errors, as the maximum threshold value T₁. Further, the learning unit 1222 may use a value obtained by subtracting three times the standard deviation from the average value of the estimation errors, as the minimum threshold value T₂.

In this way, the model generation unit 122 generates a correlation model group including each of the regression equations and an allowable range of an estimation error in the regression equation, as an analysis model.

The analysis model storage unit 15 stores analysis model information. The analysis model information indicates an analysis model generated by the analysis model generation unit 12. The analysis model information is, for example, a set of pieces of model information for respective correlation models included in the analysis model. The model information includes, for example, an identifier of a correlation model, information regarding a regression equation of the correlation model, and information indicating an allowable range of a prediction error in the regression equation. The information regarding the regression equation indicates, for example, a data item used as a response variable, a data item used as an explanatory variable, and a relational expression between the data items. Note that, the model information may further include an indicator indicating goodness of the regression equation of the correlation model (a fitness score of the correlation model).

When new state information is collected, the destruction detection unit 13 (hereinafter also simply described as a detection unit) detects presence or absence of an occurrence of model destruction for each correlation model included in the analysis model. The model destruction is a phenomenon in which an estimation error in a sensor value by a regression equation of a correlation model exceeds an allowable range.

In the example embodiments of the present invention, an occurrence of the model destruction is used as an indicator indicating that a change unrelated to a normal change is included in a change in a sensor value of a data item used as a response variable. The normal change is a change in a sensor value due to a change in a state that may usually occur in the system.

The destruction detection unit 13 detects presence or absence of an occurrence of model destruction for each correlation model included in the analysis model by using, for example, state-series information including new state information stored in the state information storage unit 14 and the analysis model. Specifically, the destruction detection unit 13 calculates an estimated value at a new time for a response variable in a regression equation of a correlation model. The destruction detection unit 13 calculates an estimation error that is a difference between the calculated estimated value and an actual sensor value, and then detects presence or absence of an occurrence of model destruction by determining whether or not the calculated estimation error satisfies an allowable range. The destruction detection unit 13 notifies the operator or the like of the detection result of the model destruction, as model destruction information, via, for example, the output device 103. The destruction detection unit 13 may also notify the monitored system 8 and the like of the model destruction information.

The model destruction information is information indicating a situation of model destruction of each correlation model included in the analysis model. The model destruction information includes information specifying a correlation model for which model destruction occurred, such as an identifier of the correlation model for which the model destruction occurred. Further, the model destruction information may include information specifying a correlation model for which model destruction did not occur. The model destruction information may include various pieces of information obtained from a correlation model, such as information regarding a data item included in a regression equation of the correlation model for which model destruction occurred (or did not occur) and a calculated prediction error. The model destruction information may include a combination of these pieces of information. Furthermore, the model destruction information may include time information of model destruction, such as a measurement time of state information for which model destruction was detected or a measurement time of state information for which the number of the model destruction detected correlation models exceeded a predetermined number.

Next, operation in the first example embodiment of the present invention will be described.

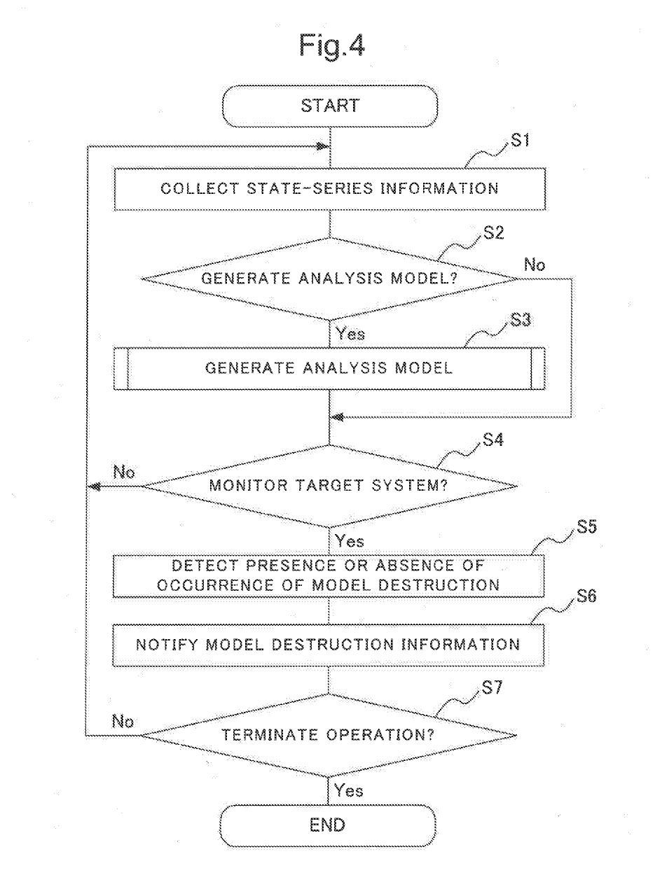

FIG. 4 is a flowchart illustrating overall operation of the system analysis device 1 in the first example embodiment of the present invention.

First, the state information collection unit 11 collects state-series information for a predetermined period from the monitored system 8, and stores the state-series information in the state information storage unit 14 (Step S1). Hereinafter, while processes in Step S2 to Step S7 are performed, the state information collection unit 11 collects state information every predetermined cycle and stores the state information in the state information storage unit 14.

When current timing is not timing to generate an analysis model (No in Step S2), processes in Step S4 and the following steps are performed.

On the other hand, when the current timing is the timing to generate the analysis model (Yes in Step S2), the analysis model generation unit 12 acquires state-series information for a predetermined period used to generate the analysis model from the state information storage unit 14. Then, the analysis model generation unit 12 generates the analysis model by using the acquired state-series information (Step S3). Details of Step S3 will be described later.

When the current timing is not timing to monitor a target system by using a current analysis model (No in Step S4), processes from Step S1 are repeated.

On the other hand, when the current timing is timing to monitor the target system by using the current analysis model (Yes in Step S4), the destruction detection unit 13 detects presence or absence of an occurrence of model destruction for state information newly collected by the state information collection unit 11 by using the analysis model (Step S5). Herein, the destruction detection unit 13 determines, for each of correlation models included in the analysis model, whether or not an estimation error for the newly collected state information exceeds an allowable range.

The destruction detection unit 13 generates model destruction information indicating an evaluation result of model destruction for each of the correlation models and notifies the model destruction information (Step S6).

Furthermore, processes from Step S1 are repeated, until timing to terminate the operation (Yes in Step S7).

Note that, in Steps S2, S4, and S7, whether to generate the analysis model, whether to monitor the target system, and whether to terminate the operation are determined, based on, for example, an input from the operator or the like via the input device 104. Further, the example embodiment is not limited to this, these may be determined by other methods, for example, based on whether or not current timing is predetermined timing, whether or not various pieces of information obtained from the monitored system 8 satisfy a predetermined condition, or the like.

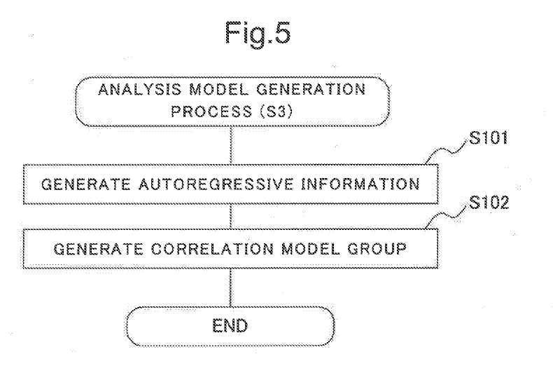

FIG. 5 is a flowchart illustrating details of the analysis model generation process (Step S3) of the system analysis device 1 in the first example embodiment of the present invention.

The autoregressive information acquisition unit 121 acquires state-series information from the state information storage unit 14 and generates autoregressive information by using the acquired state-series information (Step S101).

The model generation unit 122 generates a correlation model group by using the generated autoregressive information and the state-series information (Step S102).

Thereby, the operation in the first example embodiment of the present invention is completed.

Next, a specific example of the first example embodiment of the present invention will be described.

Herein, a prediction accuracy is used as a fitness score for an autoregressive model of a data item. Further, 0.7 is used as a threshold value of the fitness score. Thus, a condition for the fitness score is “F₁>=0.7”.

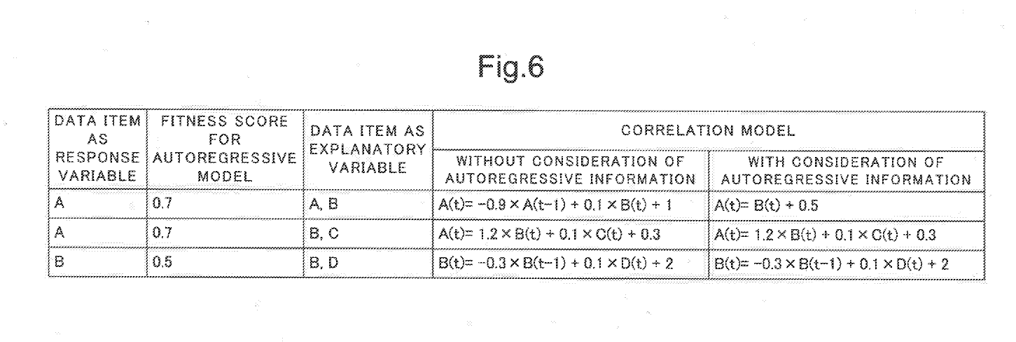

FIG. 6 is a diagram illustrating examples of generating an analysis model in the first example embodiment of the present invention. FIG. 6 illustrates, for three examples, a data item that is a response variable of a base correlation model, a fitness score of the data item for an autoregressive model, a data item used as an explanatory variable, and a correlation model generated depending on with or without consideration of autoregressive information.

The first example is a case that, in a base correlation model, a response variable is a data item A and explanatory variables are the data item A and a data item B. Since a fitness score of the data item A for an autoregressive model is 0.7, “autoregressive process is disabled” is set to autoregressive information. Herein, when the autoregressive information is not considered, a correlation model including the autoregressive process, such as A(t)=−0.9×A(t−1)+0.1×B(t)+1, is generated. However, a correlation model not including the autoregressive process such as A(t)=B(t)+0.5 is generated by considering the autoregressive information.

The second example is a case that, in the base correlation model, a response variable is the data item A and explanatory variables are the data item B and a data item C. Since a fitness score of the data item A for an autoregressive model is 0.7, “autoregressive process is disabled” is set to autoregressive information. In this case, the explanatory variables in the base correlation model do not include the data item A, and therefore a correlation model not including the autoregressive process, such as A(t)=1.2×B(t)+0.1×C(t)+0.3, is generated regardless of with or without the consideration of the autoregressive information.

The third example is a case that, in the base correlation model, a response variable is the data item B and explanatory variables are the data item B and a data item D. Since a fitness score of the data item B for an autoregressive model is 0.5, “autoregressive process is enabled” is set to autoregressive information. In this case, although the explanatory variables in the base correlation model include the data item B, a correlation model including the autoregressive process, such as B(t)=−0.3×B(t−1)+0.1×D(t)+2, is generated regardless of with or without the consideration of the autoregressive information.

Note that, in the first example embodiment of the present invention, a fitness score of a data item for an autoregressive process is calculated as a feature of the data item, and presence or absence of the autoregressive process in a correlation model is selected, based on the fitness score. However, the example embodiment is not limited to this, a feature other than a fitness score for an autoregressive process may be used as a feature of a data item, as long as a form of a correlation model to increase a prediction accuracy can be selected from different forms of the correlation model, according to the feature of the data item.

Next, a characteristic configuration according to the first example embodiment of the present invention will be described.

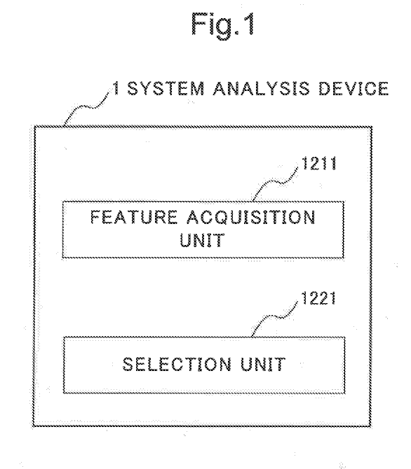

FIG. 1 is a block diagram illustrating the characteristic configuration of the first example embodiment of the present invention.

Referring to FIG. 1, a system analysis device 1 (information processing device) includes a feature acquisition unit 1211 and a selection unit 1221. The feature acquisition unit 1211 acquires a feature of a first data item. The selection unit 1221 selects a model for learning a relationship between the first data item and a second data item, based on the feature.

Next, an advantageous effect of the first example embodiment of the present invention will be described.

According to the first example embodiment of the present invention, even if the number of models is large, a model with few false reports and little missing detection can be generated. The reason is that the selection unit 1221 selects a model for learning a relationship between the first data item and the second data item, based on a feature of the first data item.

For example, as described above, a correlation model that uses a data item having a high fitness score for the autoregressive process as a response variable and includes an autoregressive process is likely to cause over-fitting. The reason is that, whit respect to the data item having a high fitness score for the autoregressive process, an estimated value of the data item can be accurately calculated with only a past value of the data item. In this case, a sensor value of a data item used only as an explanatory variable is not used to calculate the estimated value of the data item by the correlation model. Thus, even if an abnormal value appears in the sensor value of the data item used only as the explanatory variable, the estimated value may not reflect the influence, and therefore the abnormality may not be detected. Further, since past values of the response variable greatly contribute to the estimated value of the data item, an abnormality may be detected when an increase amount of the response variable from the past values is slightly smaller or even larger. In this way, a correlation model using a data item having a high fitness score for an autoregressive process as a response variable is likely to cause a false report and missing detection.

Thus, for example, a fitness score of a data item for an autoregressive process is used as a feature of the data item, and whether or not the autoregressive process is to be included into a correlation model is selected, based on the fitness score. This prevents generation of a correlation model using a data item having a high fitness score for an autoregressive process as a response variable and including the autoregressive process, namely, a correlation model that is likely to cause over-fitting. Therefore, a correlation model with fewer false reports and less missing detection is generated.

Furthermore, a feature for determining whether or not to include an autoregressive process is obtained from a data item, therefore transcendental information regarding input and output as in PTL 2 is not needed, and the first example embodiment is also easily applicable to the case where the number of models is large.

### Second Example Embodiment

A second example embodiment of the present invention will be described.

The second example embodiment of the present invention is different from the first example embodiment of the present invention in that a correlation model group satisfying a predetermined condition is extracted as an analysis model.

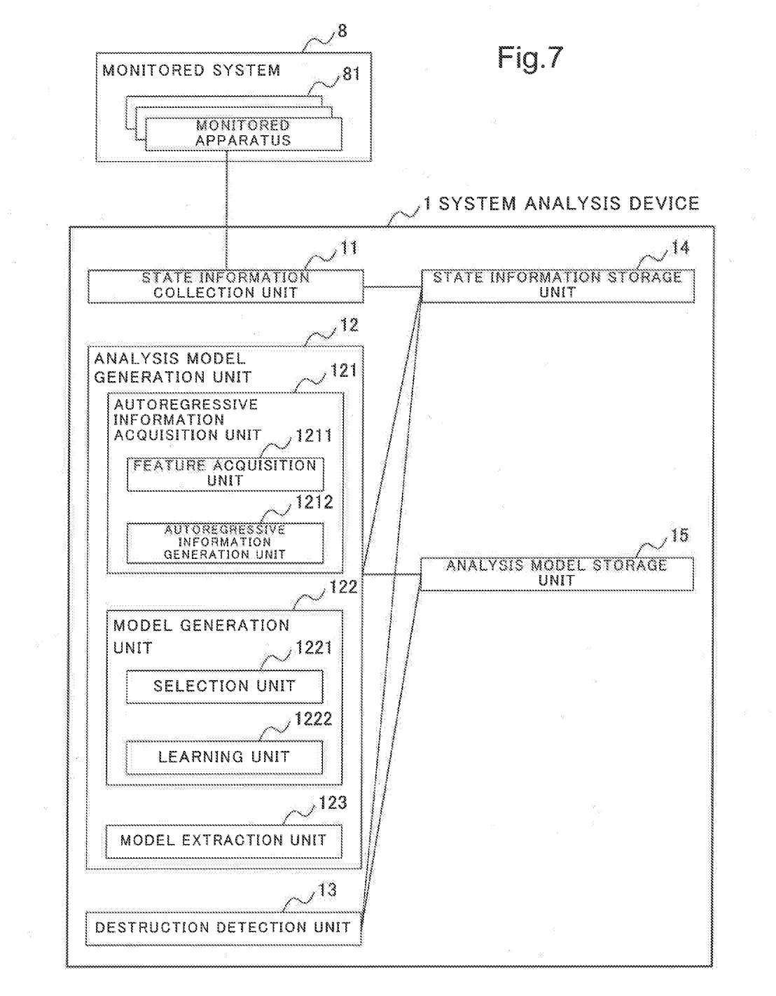

First, a configuration of the second example embodiment of the present invention will be described. FIG. 7 is a block diagram illustrating a configuration of the system analysis device 1 in the second example embodiment of the present invention. With reference to FIG. 7, an analysis model generation unit 12 in the system analysis device 1 in the second example embodiment of the present invention further includes a model extraction unit 123 in addition to the autoregressive information acquisition unit 121 and the model generation unit 122.

The model extraction unit 123 (hereinafter also simply described as an extraction unit) extracts, as an analysis model, a correlation model group satisfying a predetermined condition (fitting correlation model group) from a correlation model group generated by the model generation unit 122.

A predetermined condition for the model extraction unit 123 to extract a correlation model is that, for example, a fitness score of a correlation model (hereinafter also described as a second fitness score) is equal to or more than a predetermined threshold value. The fitness score of the correlation model is a fitness score of a regression equation of the correlation model for a relationship between data items of the correlation model, and is an indicator indicating goodness of the regression equation. Note that, the condition that “a fitness score of a correlation model is equal to or more than a predetermined threshold value” is a “predetermined fitting condition for the second fitness score”.

The model extraction unit 123 calculates a fitness score F₂ of a correlation model by using Equation 9, similarly to the method for calculating the fitness score F₁ for the autoregressive model expressed in Equation 2 described above, for example. The model extraction unit 123 uses Equation 10 below as a predetermined condition to extract a correlation model.

$$\begin{matrix}{F}_{2} = [ 1 - \sqrt{\frac{{\sum }_{t = N 0}^{N 1} {\{ u ( t ) - {u}^{″} ( t ) \}}^{2}}{{\sum }_{t = N 0}^{N 1} {\{ u ( t ) - \overline{u} ( t ) \}}^{2}}} ] & [ Equation 9 ] \\ {F}_{2} \geq {F}_{th 2} & [ Equation 10 ]\end{matrix}$$

Herein, Fₜₕ₂ is a threshold value of the fitness score F₂ (hereinafter also described as a second threshold value), and an arbitrary value is set to a value of Fₜₕ₂ by the operator or the like. A low value may be set as the value of the threshold value Fₜₕ₂, from a viewpoint of expanding a target range of abnormality detection. Further, a high value may be set as the value of the threshold value Fₜₕ₂, from a viewpoint of reducing false detection due to a change in a state of the system and the like. For example, when the fitness score F₂ takes a value of 0 to 1, the value of the threshold value Fₜₕ₂ may be 0.7 to 1, from the viewpoint of reducing false detection.

Note that, similarly to a fitness score of a data item for an autoregressive model, a fitness score of a correlation model may also be calculated by using a fitness score defined from a viewpoint of a low generalization error in addition to a fitness score defined from a viewpoint of a high estimation accuracy as in Equation 9. Note that, a fitness score of a correlation model may also be calculated by combining techniques from these viewpoints.

Next, operation in the second example embodiment of the present invention will be described.

A flowchart illustrating overall operation of the system analysis device 1 in the second example embodiment of the present invention is the same as the flowchart (FIG. 4) in the first example embodiment of the present invention.

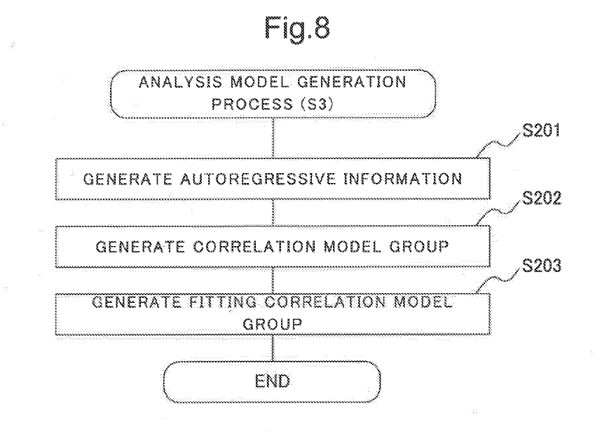

FIG. 8 is a flowchart illustrating details of the analysis model generation process (Step S3) of the system analysis device 1 in the second example embodiment of the present invention.

The autoregressive information acquisition unit 121 acquires state-series information from a state information storage unit 14 and generates autoregressive information by using the acquired state-series information (Step S201).

The model generation unit 122 generates a correlation model group by using the generated autoregressive information and the state-series information (Step S202).

The model extraction unit 123 extracts a fitting correlation model group, as an analysis model, from the generated correlation model group, based on a fitness score of the correlation model (Step S203).

Thereby, the operation in the second example embodiment of the present invention is completed.

Next, an advantageous effect of the second example embodiment of the present invention will be described.

According to the second example embodiment of the present invention, the operator or the like can appropriately determine a proportion of false reports and a proportion of missing detection, in addition to the advantageous effect of the first example embodiment of the present invention. The reason is that the model extraction unit 123 extracts a fitting correlation model group, as an analysis model, based on a fitness score of a correlation model.

In the above-described first example embodiment, a correlation model group with few false reports and little missing detection is generated, but a false report and missing detection have a trade-off relationship therebetween. According to the second example embodiment, when a correlation model having a low fitness score is also included in the analysis model, by adjusting a threshold value for a fitness score of a correlation model, a proportion of false reports is increased. On the other hand, when only a correlation model having a high fitness score is included in the analysis model, a proportion of missing detection is increased. In this way, the operator or the like can select, by adjusting the threshold value for a fitness score of a correlation model, a correlation model with intended sensitivity.

### Third Example Embodiment

A third example embodiment of the present invention will be described.

The third example embodiment of the present invention is different from the second example embodiment of the present invention in that relearning is performed with a correlation model not including an autoregressive process for a correlation model including the autoregressive process.

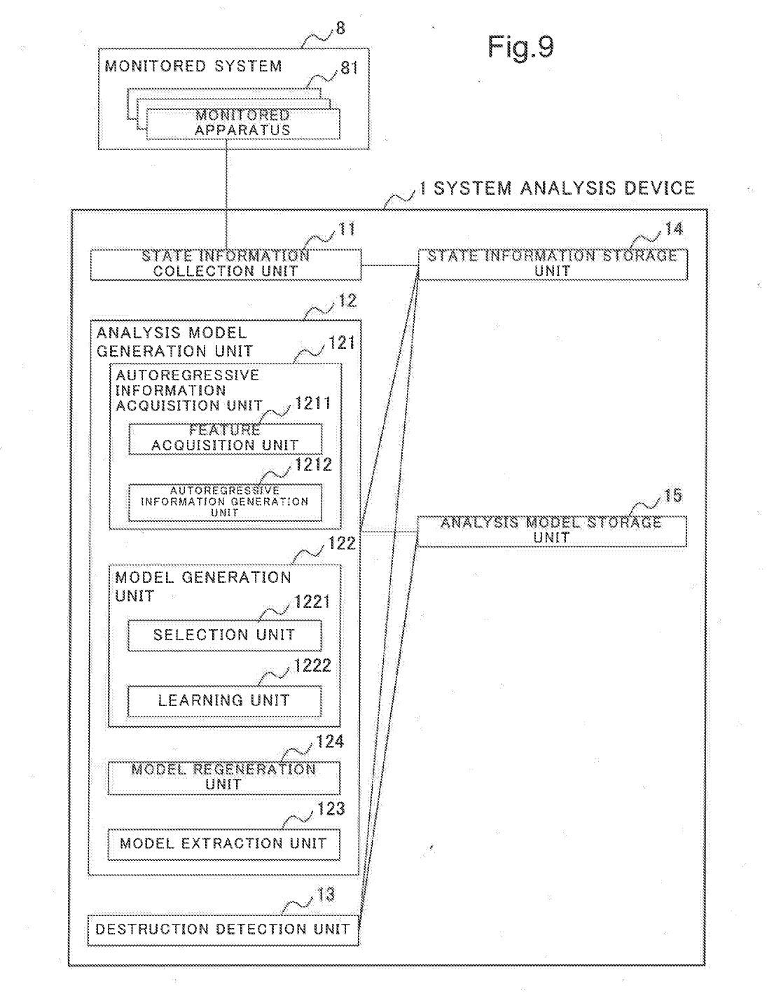

First, a configuration of the third example embodiment of the present invention will be described. FIG. 9 is a block diagram illustrating a configuration of the system analysis device 1 in the third example embodiment of the present invention. With reference to FIG. 9, the analysis model generation unit 12 in the system analysis device 1 in the third example embodiment of the present invention further includes a model regeneration unit 124 (hereinafter also described as a regeneration unit) in addition to the autoregressive information acquisition unit 121, the model generation unit 122, and the model extraction unit 123.

In the third example embodiment of the present invention, indicators comparable each other are used, as a first fitness score (a fitness score of a data item for an autoregressive process) and a second fitness (a fitness score of a correlation model). As the indicators comparable each other, indicators based on the same definition, such as an estimation accuracy of a regression equation, are used. Alternatively, as the indicators comparable each other, indicators based on different definitions but convertable to each other with a conversion table or the like, such as a likelihood and an Akaike's information criterion (AIC), may also be used. Further, different values may be individually set as a threshold value (first threshold value) for the first fitness score and a threshold value (second threshold value) for the second fitness score.

For example, the fitness score F₁ as in Equation 2 and the fitness score F₂ as in Equation 9 based on the same definition (estimation accuracy of a regression equation) are respectively used for the first fitness score and the second fitness score. In this case, a condition of Equation 3 and a condition of Equation 10 are respectively used as a predetermined fitting condition for the first fitness score and a predetermined fitting condition for the second fitness score. Herein, the first threshold value Fₜₕ₁ in Equation 3 and the second threshold value Fₜₕ₂ in Equation 10 may be different.

The model regeneration unit 124 relearns, for a correlation model (regeneration target model) including a autoregressive process having a fitness score (first fitness score) for the autoregressive process equal to or more than a threshold value (second threshold value) for a fitness score of the correlation model, a relationship between data items with the regression equation not including an autoregressive process. Such a correlation model (regeneration target model) is a correlation model having the fitness score (first fitness score) for the autoregressive process being equal to or more than the threshold value (second threshold value) for the fitness score of the correlation model and being less than a threshold value (first threshold value) for the fitness score for the autoregressive process. The model regeneration unit 124 relearns the relationship between data items by the same method as that of the model generation unit 122.

Next, operation in the third example embodiment of the present invention will be described.

A flowchart illustrating overall operation of the system analysis device 1 in the third example embodiment of the present invention is the same as the flowchart (FIG. 4) in the first example embodiment of the present invention.

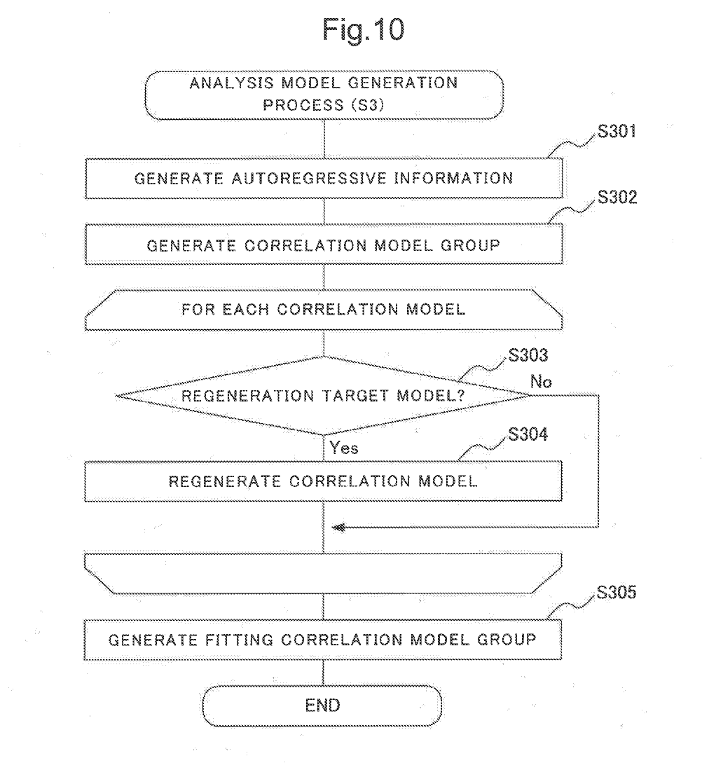

FIG. 10 is a flowchart illustrating details of the analysis model generation process (Step S3) of the system analysis device 1 in the third example embodiment of the present invention.

The autoregressive information acquisition unit 121 acquires state-series information from the state information storage unit 14, and then generates autoregressive information by using the acquired state-series information (Step S301).

The model generation unit 122 generates a correlation model group by using the generated autoregressive information and the state-series information (Step S302).

The model regeneration unit 124 determines whether or not each of the generated correlation models is the above-described regeneration target model (Step S303). When the correlation model is the regeneration target model (Yes in Step S303), the model regeneration unit 124 regenerates a correlation model with a regression equation not including an autoregressive process (Step S304).

When Steps S303 to S304 are executed on all of the generated correlation models, the model extraction unit 123 extracts a fitting correlation model group as the analysis model from the generated correlation model group (Step S305).

Thereby, the operations in the third example embodiment of the present invention is completed.

Next, an advantageous effect of the third example embodiment of the present invention will be described.

According to the third example embodiment of the present invention, the system can be monitored with a wider monitoring range, in addition to the advantageous effect of the second example embodiment of the present invention. The reason is that the model regeneration unit 124 performs relearning, with a regression equation not including an autoregressive process, for a correlation model (regeneration target model) including the autoregressive process and having a fitness score (first fitness score) for the autoregressive process equal to or more than a threshold value (second threshold value) for a fitness score of the correlation model.

It is effective to include a correlation model having a low fitness score (second fitness score) of the correlation model in an analysis model, by reducing, for example, a threshold value (second threshold value) for the fitness score of the correlation model, in order to expand a monitoring range of the analysis model. This increases the number of relationships between data items and the number of data items included in the analysis model. However, an estimation accuracy of a correlation model having a low fitness score is lower than that of a correlation model having high a fitness score. This is likely to cause a false report and missing detection.

Herein, it is assumed that a correlation model having a fitness score (first fitness score) for an autoregressive process equal to or more than the threshold value (second threshold value) for a fitness score of the correlation model includes an autoregressive process. In this case, the fitness score (second fitness score) of the correlation model satisfies the threshold value (second threshold value) for a fitness score of the correlation model, regardless of a data item used only as an explanatory variable. Therefore, the correlation model is extracted as an analysis model. In such a correlation model, an estimated value does not reflect the influence of the data item used only as the explanatory variable, and thus a false report and missing detection are likely to occur in particular. Thus, a relationship between data items is relearned with a regression equation not including the autoregressive process, for such a correlation model including the autoregressive process having the fitness score (first fitness score) for the autoregressive process equal to or more than the threshold value (second threshold value) for the fitness score of the correlation model. In this way, such a correlation model in which a false report and missing detection are likely to occur in particular is eliminated from the analysis model. In other words, even if the threshold value (second threshold value) for the fitness score of the correlation model is reduced, a monitoring range can be expanded while suppressing the possibility of a false report and missing detection.

Note that, in the above-described second and third example embodiments of the present invention, a fitness score of a correlation model is calculated from state information used to generate the correlation model. The example embodiments are not limited to this, and a fitness score of a correlation model may be calculated from state information that is not used to generate the correlation model. For example, the analysis model generation unit 12 may calculate the fitness score F₂ of a correlation model from state information that is not used to generate the correlation model. Alternatively, as another example, the analysis model generation unit 12 may generate model destruction information regarding a correlation model from state information that is not used to generate the correlation model, and calculate the fitness score F₂ of the correlation model from the model destruction information. When the fitness score F₂ of the correlation model is obtained from the model destruction information, for example, 1−(detection frequency of the model destruction for the correlation model)/(the number of indexes of state information used to generate the model destruction information) may be used as the fitness score F₂ of the correlation model. Further, the analysis model generation unit 12 may extract a fitting correlation model group, based on a fitness score of a correlation model calculated from state information used to generate the correlation model and a fitness score of a correlation model calculated from state information not used to generate the correlation model. When the fitting correlation model group is extracted by using multiple fitness scores, the analysis model generation unit 12 may extract a correlation model having the multiple fitness scores respectively exceeding threshold values preset by the operator or the like, as a fitting correlation model.

In each of the above-described example embodiments of the present invention, as an example, the monitored system 8 is a power generating plant system. The example embodiments are not limited to this, and the monitored system 8 may be any other systems, as long as the system can generate one or more correlation models from information indicating a state of the monitored system 8 and can determine presence or absence of an occurrence of an abnormality due to model destruction of the one or more correlation models. For example, the monitored system 8 may be an ICT system, a plant system, a structure, transportation equipment, and the like. Even if the monitored system 8 is such systems, the system analysis device 1 in each of the example embodiments can generate an analysis model by using a data item included in information indicating a state of the monitored system 8 and detect model destruction.

In each of the above-described example embodiments of the present invention, each of the structural components (functional blocks) of the system analysis device 1 is implemented on the CPU executing the computer program stored in the storage device or the ROM. The example embodiments are not limited to this, and a part or the whole of the structural components or a combination of the structural components may implemented on dedicated hardware.

In each of the above-described example embodiments of the present invention, each of the structural components (functional blocks) of the system analysis device 1 may be disposed in a plurality of devices in a distributed manner.

In each of the above-described example embodiments of the present invention, the operation of the system analysis device 1 described with reference to each of the flowcharts may be stored in a storage device (storage medium) of a computer device, as a computer program of the present invention. Then, the CPU may read and execute the computer program. In this case, the present invention includes a code of the computer program or the storage medium.

In each of the above-described example embodiments of the present invention, the system analysis device 1 may output a screen for adjusting a threshold value of a fitness score for an autoregressive model or selecting whether or not to use autoregressive information to generate an analysis model, to the operator or the like via the output device 103.

In each of the above-described example embodiments of the present invention, the system analysis device 1 may include a function of narrowing a location of an abnormality, as in PTL 3.

The above-described example embodiments can be appropriately combined and carried out.

While the present invention has been particularly shown and described with reference to the example embodiments thereof, the present invention is not limited to the embodiments. It will be understood by those of ordinary skill in the art that various changes in form and details may be made therein without departing from the spirit and scope of the present invention as defined by the claims.

This application is based upon and claims the benefit of priority from Japanese patent application No. 2016-009879, filed on Jan. 21, 2016, the disclosure of which is incorporated herein in its entirety by reference.

### REFERENCE SIGNS LIST

1 System analysis device
11 State information collection unit
12 Analysis model generation unit
121 Autoregressive information acquisition unit
1211 Feature acquisition unit
1212 Autoregressive information generation unit
122 Model generation unit
1221 Selection unit
1222 Learning unit
123 Model extraction unit
124 Model regeneration unit
13 Destruction detection unit
14 State information storage unit
15 Analysis model storage unit
101 CPU
102 Memory
103 Output device
104 Input device
105 Network interface
8 Monitored system
81 Monitored apparatus

1. An information processing device comprising:
a memory storing instructions; and
one or more processors configured to execute the instructions to: acquire a feature of a first data item; and
select a model for learning a relationship between the first data item and a second data item, based on the feature.

2. The information processing device according to claim 1, wherein,
as the feature of the first data item, a first fitness score that is a fitness score of the first data item for an autoregressive process is acquired, and
whether an autoregressive process of the first data item is to be included into the model or not is selected, based on the first fitness score.

3. The information processing device according to claim 2, wherein
the one or more processors configured to further execute the instructions to:
learn a relationship between the first data item and the second data item by using the selected model; and
detect an abnormality in the first data item or the second data item by using the model used for learning the relationship.

4. The information processing device according to claim 3, wherein
the one or more processors configured to further execute the instructions to:
calculate a second fitness score that is a fitness score of the model used for learning the relationship for the relationship, and extract a model for detecting the abnormality from the model used for learning the relationship, based on the second fitness score.

5. The information processing device according to claim 4, wherein,
when the first fitness score is equal to or more than a first threshold value, the model not including an autoregressive process of the first data item is selected,
a model having the second fitness score equal to or more than a second threshold value is extracted as a model for detecting the abnormality, and
the one or more processors configured to further execute the instructions to:
select, when the first fitness score is equal to or more than the second threshold value, the model not including an autoregressive process of the first data item, and relearn the relationship by using the selected model.

6. An information processing method comprising:
acquiring a feature of a first data item; and
selecting a model for learning a relationship between the first data item and a second data item, based on the feature.

7. The information processing method according to claim 6, wherein
the acquiring acquires, as the feature of the first data item, a first fitness score that is a fitness score of the first data item for an autoregressive process, and
the selecting selects whether an autoregressive process of the first data item is to be included into the model or not, based on the first fitness score.

8. The information processing method according to claim 7, further comprising:
learning a relationship between the first data item and the second data item by using the selected model; and
detecting an abnormality in the first data item or the second data item by using the model used for learning the relationship.

9. The information processing method according to claim 8, further comprising:
calculating a second fitness score that is a fitness score of the model used for learning the relationship for the relationship, and extracting a model for detecting the abnormality from the model used for learning the relationship, based on the second fitness score.

10. A non-transitory computer readable storage medium recording thereon a program causing a computer to perform a method comprising:
acquiring a feature of a first data item; and
selecting a model for learning a relationship between the first data item and a second data item, based on the feature.
